(19) United States
(12) Patent Application Publication
(10) Pub. No.: US 2001/0051952 A1
(43) Pub. Date: Dec. 13, 2001

(54) Sample analyzing system for facilitating control and maintenance of registered information

(75) Inventor: Toshiaki Nakazato, Tochigi-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/819,649

(22) Filed: Mar. 29, 2001

(30) Foreign Application Priority Data
Mar. 29, 2000 (JP) 2000-091452

(51) Int. Cl. G06F 17/30; G06F 15/16

(52) U.S. Cl. 707/104.1; 707/204; 707/10; 709/217

(57) ABSTRACT

A sample analyzing system in which backup for sample analysis for blood serum can be carried out easily, thereby improving reliability and reducing both the workload for information control and maintenance, and recovery time; The sample analyzing system being capable of being controlled and operated from other apparatus or from a remote place is disclosed. This sample analyzing system controls various kinds of information such as reagent information, measuring conditions, working curve data and item measuring definition information in a sample analysis controller as an operating parameter for the analyzing system. In the analysis related information database provided with this analyzing system, its hard disk drive is divided to plural units or partitions and used for back up under a predetermined condition. Further, by controlling information with markup language, remote maintenance is provided.

### CROSS-REFERENCE TO RELATED APPLICATIONS

This application is based upon and claims the benefit of priority from the prior Japanese Patent Application No. 2000-91452, filed on Mar. 29, 2000; the entire contents of which are incorporated herein by reference.

### BACKGROUND OF THE INVENTION

1. Field of the Invention

The present invention relates to a sample analyzing system for facilitating control and maintenance of sample analysis information, and more particularly to technology for reducing the control and maintenance workload by making it possible to identify and retrieve information relating to registered sample analysis in clinical analysis for the analysis of the component of sample such as blood serum.

2. Description of the Background Art

In conventional automatic clinical sample component analysis apparatus, first, the sample to be measured such as blood serum is collected in a cup or blood collecting tube and this cup or blood collecting tube is disposed on a sample rack and then, placed in a sampler in the apparatus. Next, sample information about the sample and request information about the component to be measured are registered in the sample analyzing apparatus for each sample and then measurement is carried out.

This measurement involves, more specifically, a solution for dilution or a dedicated reagent depending on the request item being added to a target sample, agitated thereof and then the absorbance and potential are measured. Next, an analysis result (density) is obtained based on a working curve created with a reference sample whose density is previously specified. The analysis result obtained in this way along with sample information of the target sample is outputted through screen display, printing and on-line output.

This series of the sample analysts is achieved when software having sample measuring and analyzing function controls various kinds of hardware units according to input of a number of measuring condition, sample information and request information.

FIG. 1 shows an example of the configuration of the hardware units. The hardware unit comprises a sample analyzing apparatus and a console unit incorporating mechanism for controlling the sample analyzing apparatus and inputting/outputting information necessary for sample analysis.

Information used in measurement and analysis of the aforementioned series of the samples includes, for example, definition information of measuring item, reagent information, reference sample information, result printout format, configuration information of sample analyzing system, measuring condition, maintenance information, facility information and log information about error and the like. Further information which can be obtained by measurement of the sample includes working curve data, quality control (QC) data, analysis result data etc.

Recently, these kinds of information, request information for aforementioned measurement and the analysis result data can be mutually transmitted between remote systems easily through network connection or on-line connection with a remote laboratory information system (LIS) or hospital information system (HIS).

On the other hand, due to the increase in the quantity of specimens, diversification of sample measuring items and necessity of taking measures against system failure, it is expected that the situation where plural units of the sample analyzing apparatuses of the same type or different type are provided in a laboratory will become more widespread. Moreover, the number of measuring items which can be measured by a single sample analyzing apparatus has been increasing year by year. For this reason, it is anticipated that information processed in the aforementioned sample analyzing apparatus will continue to become more and more complicated thereby further increasing the volume of information.

Under these considerations, a demand for an automatic analyzing apparatus which satisfies the following requirements has been generated.

(1) Ability to backup and recover information registered in the apparatus for reducing the down-time of the sample analysis apparatus in cases of hardware failure.

(2) Ability to easily retrieve reagent information and reference sample information, based on each maaufacturer's data-sheet thereby reducing the workload of the operator and keeping the information updated.

(3) Ability to easily retrieve item definition information for defining detail measurement item and to update it.

(4) Ability to update the inherent information of a facility where the apparatus is to be installed, contained in the apparatus easily depending on changes of the information.

(5) Ability to control the system configuration, measuring conditions, maintenance information and log information of the apparatus from a remote place; i.e. remote maintenance of sample analyzing apparatus from a remote service center with the aim of reduction of down-time.

(6) Ability to retrieve sample data to be measured, working curve data and QC data as comprehensive information.

(7) Ability to share registered information between local or remote sample analyzing apparatuses.

Generally, there is an automatic analyzing apparatus incorporating a system for retrieving each data from the sample analyzing apparatus in the form of a text file of comma separate value (CSV) format for outside computer to analyze.

However, ordinarily, all this data is stored such that the content and information disposition thereof are in the form of binary file for each unit to prevent an unauthorized person from easily interpreting them.

Thus, in terms of output, unless dedicated software is used, the content of the binary file cannot be displayed or edited.

On the other hand, in terms of input, to fetch (retrieve) information into the sample analyzing apparatus, there is not any method other than the operator manually inputting a tremendous amount of information such as the aforementioned sample information and reference sample information.

Further, according to conventional art, information held in the sample analyzing apparatus cannot be backed up or recovered quickly. Particularly, in cases where backup is carried out on the same disk, if that disk is destroyed for some reason, the recovery is disabled. In the case of a FD or MO having a small capacity, it takes much time and labor to back up all data quickly and securely, which can be very hard work.

Further, even if mirroring the disk, which is a generally used technology, is employed, not only information which a system administrator desires to store cannot be stored sufficiently, but also the condition to be updated by mirroring is not always the condition which he desires to back up.

Furthermore, a file for storing various kinds of information is constituted of binary format, the content and disposition thereof differ depending on the type of the apparatus. Thus, the information cannot be retrieved (fetched out) in any other format than its original format and further, cannot be set up or registered in any method other than manual operation.

Further, information cannot be shared among different apparatuses of the same type or among different types, so that the information cannot be displayed or edited until any dedicated software is employed.

### SUMMARY OF THE INVENTION

An object of the present invention is to provide a sample analyzing system for facilitating control and maintenance of information by organizing various kinds of information relating to the analysis of a sample held in the sample analyzing apparatus in such a way that the content of each data item can be recognized easily by an operator.

Another object of the present invention is to provide a system for backing up information held in the sample analyzing apparatus easily to avoid problems for the operator and reducing the time necessary for recovery, thereby improving the reliability of the sample analyzing apparatus and reducing the system operation workload.

Still another object of the present invention is to provide an analysis apparatus, the control and operation of which can be carried out from a remote place.

According to an aspect of the present invention, there is provided a sample analyzing system for analyzing a sample, comprising: an analyzing unit for analyzing requested item of a measured sample; an analysis related information database for holding analysis related information necessary for analyzing said sample; a database manager for storing inputted said analysis related information into said analysis related information database and outputting information from said analysis related information database; and a controller for controlling storing said analysis related information into said analysts related information database and outputting therefrom in a file format complete with a header defining a data item identifier for each data item.

According to another aspect of the present invention, there is provided a sample analyzing system for analyzing a sample, comprising: an analyzing unit for analyzing requested item of a measured sample; an analysis related information database for holding analysis; related information necessary for analyzing said sample; a database manager for storing inputted said analysis related information into said analysis related information database and outputting information from said analysis related information database; and a controller for converting said analysis related information into a file format complete with a header defining a data item identifier for each data item when storing said analysis related information into said analysis related information database and outputting therefrom.

According to another aspect of the present invention, there is provided a sample analyzing system for analyzing a sample, comprising: an analyzing unit for analyzing requested item of a measured sample; a first storage device for holding analysis related information necessary for analyzing said sample; a database manager for storing inputted said analysis related information into said first storage device and outputting information from said first storage device; and a backup recovery processor for backing up all or part of said analysis related information stored in said first storage device into a separate second storage device other than said first storage device, and, if necessary, restoring the backed up analysis related information in said second storage device into said first storage device.

Other features and advantages of the present invention will become apparent from the following description taken in conjunction with the accompanying drawings.

### BRIEF DESCRIPTION OF DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing an example of system configuration of a sample analyzing apparatus;

FIG. 2 is a block diagram showing the structure of a sample analyzing apparatus according to a first embodiment of the present invention;

FIG. 3 is a diagram showing the configuration of an analysis related information database of the sample analyzing apparatus according to the first embodiment of the present invention of FIG. 2;

FIG. 4 is a diagram showing an example of hardware configuration of the sample analyzing apparatus according to the first embodiment;

FIG. 5 is a diagram showing an example of hardware configuration employed for backup for the analysis related information database;

FIG. 6 is a diagram for explaining an example of backup/recovery instructing display screen in an I/O controller in the sample analyzing apparatus according to the first embodiment of the present invention;

FIG. 7 is a diagram for explaining an example of the content of CSV file stored in an analysis related information database according to a second embodiment of the present invention;

FIG. 8 is a diagram showing an example of a retrieval result display screen corresponding to reagent information library outputted by an I/O controller of the sample analyzing apparatus according to the second embodiment of the present invention;

FIG. 9 is a diagram showing an example of reagent disposition setting instructing screen outputted by the I/O controller of the sample analyzing apparatus according to the second embodiment of the present invention;

FIG. 10 is a diagram for explaining an example of the content of XML file stored in the analysis related information database according to a third embodiment of the present invention; and

FIG. 11 is a diagram showing an example of an output screen outputted by the display unit through a viewer, indicating the content of XML file stored in the analysis related information database according to the third embodiment of the present invention.

### DETAILED DESCRIPTION OF THE PREFERRED EMBODIMENTS

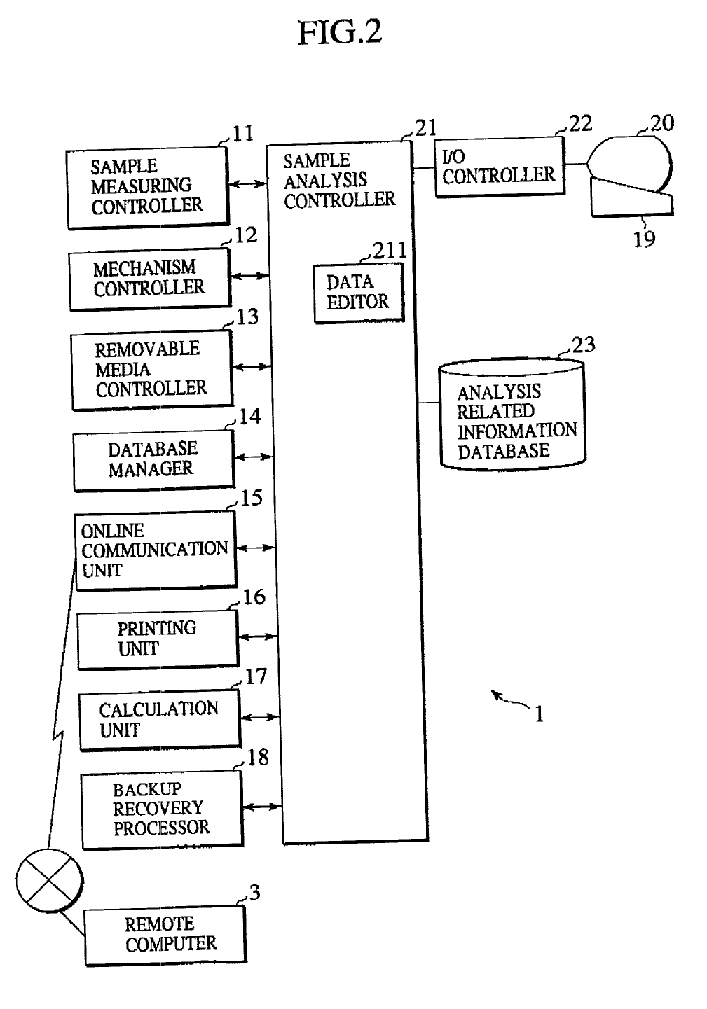

Hereinafter, the preferred embodiments of the sample analyzing system according to the present invention will be described in detail with reference to FIGS. 2 to 11.

First Embodiment

Next, the first embodiment of the present invention will be described in detail with reference to FIGS. 2 to 6. According to the first embodiment, the function for automatically and entirely carrying out the backup process for the tremendous amount of information necessary for sample analysis is provided.

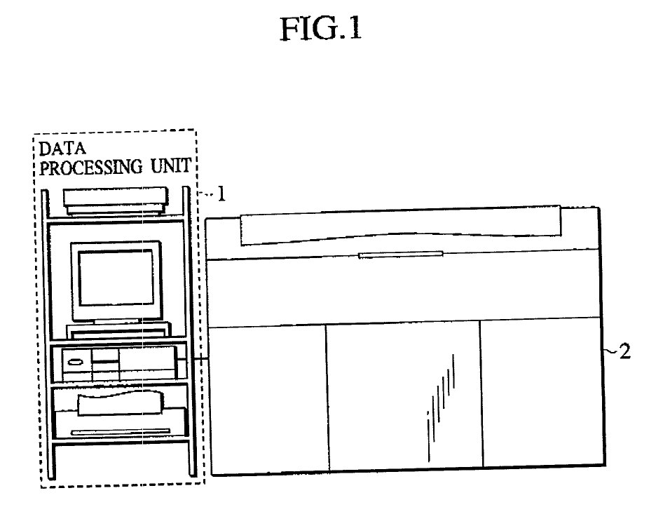

FIG. 2 is a block diagram showing the structure of a sample analysis control apparatus 1 according to the first embodiment of the present invention. As shown in FIG. 1, the sample analyzing system of the first embodiment comprises an analyzing unit 2 for executing measurement and analysis of sample and a sample analysis control apparatus which is data processing unit 1.

As shown in FIG. 2, the sample analysis control apparatus 1 according to the first embodiment of the present invention comprises a sample measuring controller 11, a mechanism controller 12, a removable media controller 13, a database manager 14, an online-communication unit 15, a printing unit 16, an calculation unit 17, a backup recovery processor 18, a sample analysis controller 21, an input/output control portion 22, an analysis related information database 23, an input unit 19 and a display unit 20. The sample analysis controller 21 carries out data format conversion by, if required, calling an data editor 211 when accessing the analysis related information database 23.

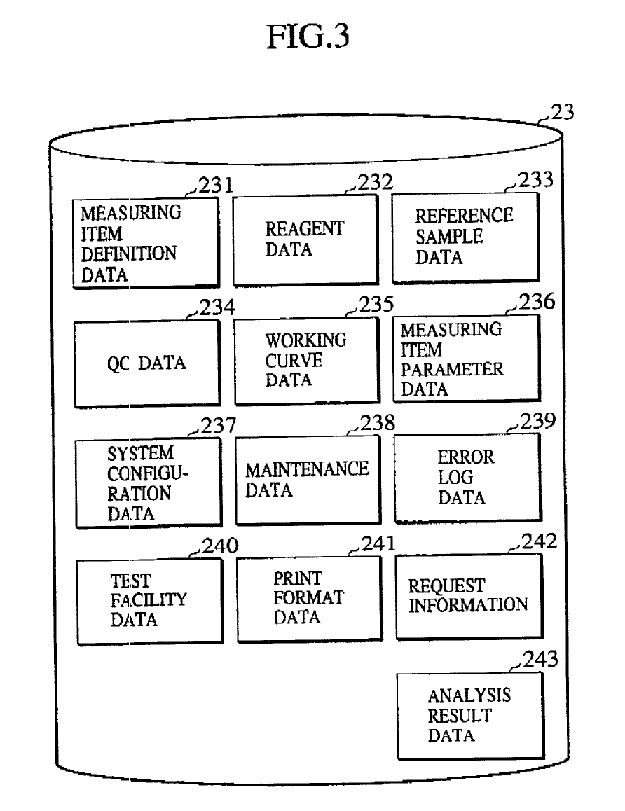

FIG. 3 shows details of the data stored in the analysis related information database 23. The analysis related information database 23 stores measuring item definition data 231, reagent data 232, reference sample data 233, quality control data 234, working curve data 235, measuring item parameter data 236, system configuration data 237, maintenance data 238, error log data 239, test facility data 240, print format data 241, request information 242, and analysis result data 243. The system configuration data 237 contains at least an identifier for identifying a unit itself. The test facility data 240 contains correction information for use in correcting the measurement result in an appropriate unit. The test facility data 240 also contains information about a software configuration and a hardware configuration. The software configuration information is information indicating a network setting, a printing setting, a sound setting, an operation condition, whether or not an optional software is installed and a kind thereof, etc. The hardware configuration information is information indicating a kind of a printer connected to the apparatus, whether or not an optional hardware is attached and a kind thereof.

The measuring item indicates a measurement item for the sample, for example, protein, neutral fat and electrolyte (sodium, kalium etc).

The sample measuring controller 11 makes analyzing unit 2 execute measurement of sample (for example, blood serum, urine) of the specimen. The mechanism controller 12 controls an operation (for example, measuring order of the sample) of each mechanism relating to analysis of sample. The removable media controller 13 controls attachment/detachment of a removable disc (FD, MO, DVD-RAM and the like) for use in data backup and input/output therefor. The database manager 14 sets and stores the aforementioned information imported from outside units through the online-communication unit 15 or the input unit 19 in the analysis related information database 23. The online-communication unit 15 carries out data transmission and reception between the sample analysis control apparatus 1 and outside computer unit. The printing unit 16 prints and outputs information stored in the analysis related information database 23 according to control of the sample analysis controller 21. The calculation unit 17 analyzes a measurement result by carrying out arithmetic operation such as inter-item operation and re-operation according to the measurement result. The backup recovery processor 18 backs up all or part of data in the analysis related information database 23 and restores it as required. The sample analysis controller 21 controls processing in: the sample measuring controller 11, mechanism controller 12, removable media controller 13, database manager 14, online-communication unit 15, printing unit 16, calculation unit 17, input/output (I/O) controller 22, analysis related information database 23, input unit 19, and display unit 20. The sample analysis controller 21 edits information stored in the analysis related information database 23 and transfers it to the input/output control portion 22 for controlling the output. The input/output control portion 22 edits the content to be displayed and controls input/output through the display unit 20.

Further, the sample analysts controller 21 imports reference sample library for storing reference data about reference sample which serves for a reference for analysis, reagent library for storing data about reagent for use in measurement of sample (these are provided by manufacturers of reference sample or reagent) and parameter information about measurement item to the analysis related information database 23 through the online-communication unit 15 or removable media controller 13. The reference sample library, reagent library, measurement result, QC data and item parameter are exported outside by means of the online-communication unit 15 and the removable media controller 13.

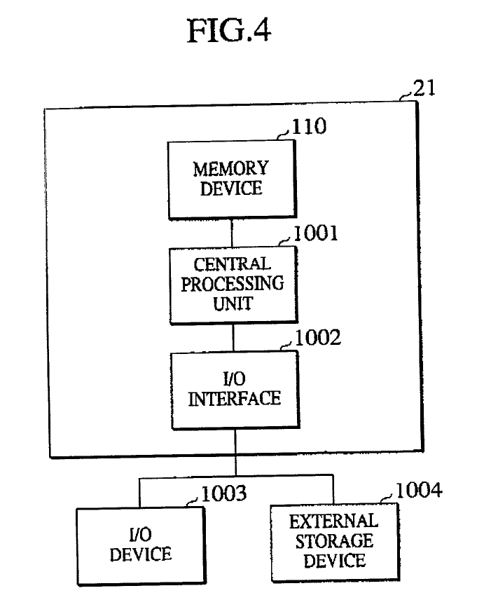

As shown in FIG. 4, the sample analysis control unit 1 which contains the sample analysis controller 21 comprises a memory device 110, a CPU 1001, and an I/O interface 1002 for controlling I/O device 1003 and external memory device 1004.

The sample measuring controller 11, mechanism controller 12, removable media controller 13, online-communication unit 15 and printing unit 16 controlled by the sample analysis controller 21 are constituted of various mechanisms, hardware and control software within the sample analyzing system.

The database manager 14 and the input/output controller 22 controlled by the sample analysis controller 21 are constituted of a software for controlling user interface for exchange of information between an operator and a computer.

Next, control and operation procedure for sample analysis and sample related information according to the first embodiment will be described.

In the above described structure indicated in FIGS. 2, 3, prior to analysis of the sample, the sample analysis controller 21 reads various kinds of information such as the measuring item definition data 231, the reagent data 232, the reference sample data 233, the quality control data 234, the working curve data 235, the measuring item parameter data 236, the system configuration data 237, the maintenance data 238, the error log data 239, the test facility data 240 and the print format data 241. At the same time, the sample analysis controller 21 reads these various kinds of information from manual input by the operator or through the removable media controller 13 and registers them in the analysis related information database 23 through the database manager 14.

According to the request information 242 obtained from manual input by the operator through the input unit 19, or through the removable media controller 13 or the online-communication unit 15, the sample analysis controller 21 controls the sample measuring controller 11 and the mechanism controller 12 to enable it to measure for a measurement target sample. The sample analysis controller 21 controls the calculation unit 17 so as to execute an analysis of the measurement result. The measurement result is stored in the analysis related information database 23 and displayed on the display unit 20 through the input/output controller 22. The displayed measurement result information can be displayed and edited through the input/output controller 22.

Of the measurement result, data about the working curve and data about quality control (QC) is stored in the analysis related information database 23 as working curve data 235 and quality control data 234 and displayed through the input/output controller 22. The displayed working curve data 235 and QC data 234 can be displayed and edited through the input/output controller 22.

Maintenance data 238 such as the operating frequency of the sample analysis control apparatus 1 is stored in the analysis related information database 23 corresponding to an operation of the apparatus and displayed through the input/output controller 22.

Error information which is generated during an operation of the sample analysis control apparatus 1 is stored in the analysis related information database 23 as error log data 239 corresponding to an occurrence of the error and then displayed through the input/output controller 22.

Analysis result data 243 is transmitted to a host computer installed in, for example, a service center and connected to the sample analysis control apparatus 1 through the online-communication unit 15 or printed out by the printing unit 16 automatically or at the instruction of the operator.

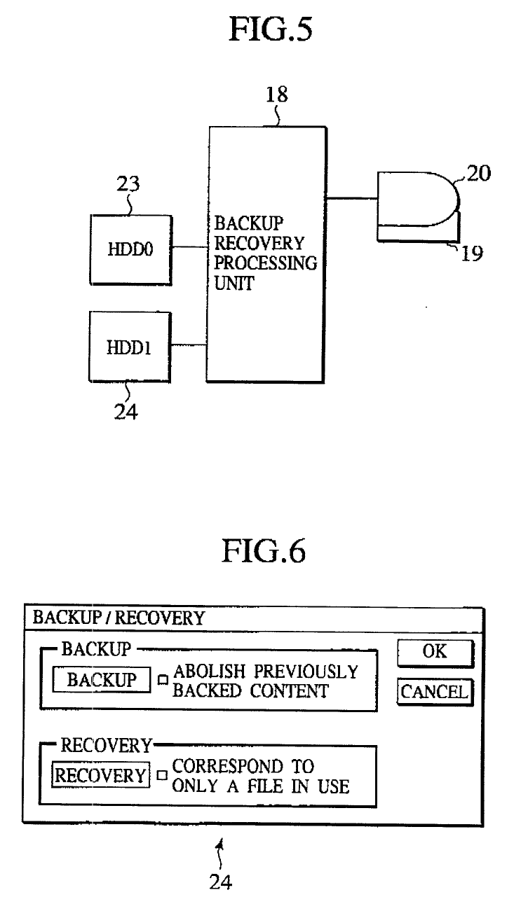

FIG. 5 shows an example of hardware structure of a storage means for storing the analysis related information database 23 according to the first embodiment of the present invention.

As the storage means, two arbitrary units of external storage devices such as hard disk (HDD) are provided. In this configuration, the first hard disk 23 serves for primary hard disk drive usually used. Regions in this hard disk are divided into C: a system partition containing OS, D: a control software partition of the automatic sample analyzing apparatus and E: data partition for sample related database 23 to be registered in the apparatus. Secondary hard disk 24 is dedicated to a data backup and contains F: backup partition.

FIG. 6 shows an example of an instruction screen for backup processing.

A control screen shown in FIG. 6 is displayed on the display unit 20 and the operator can carry out data backup and recovery of the analyzing apparatus of the present invention by operation through the input unit 19 according to this screen. Upon this data backup, the content of the aforementioned partition E is transferred to partition F and upon this recovery operation, the procedure is reversed. As shown in FIG. 6, as an option for this backup operation, it can be selected to abolish previously backed up content backed up previously is abolished, so that the content to be backed up can be clarified.

As a condition for producing the backup, manual or automatic backup, can be carried out, for example, before manual or automatic power OFF.

The backup targets consists of all kinds of information including the measuring item definition data 231, the reagent data 232, the reference sample data 233, the quality control data 234, the working curve data 235, the measuring item parameter data 236, the system configuration data 237, maintenance data 238, the error log data 239, the test facility data 240, the print format data 241 and the request information 242 and the analysis result data 243, as stored in the analysis related information database 23.

In this creation of the backup, backup target data can be provided in steps, in accordance with the volume of data targeted for backup. For example, only a device identifier and correction information are set up as a first step, data in which the reagent data 232 and sample data are added to the device identifier and the correction information are set up as a second step and then data in which the analysis result data 243 is added to these is set up as a third step. The operator can select the step in the backup instruction screen shown in FIG. 6.

Further, automatic backup will occur under predetermined condition and for example, may also be carried out under a situation in which the state of the device has changed, as in measurement startup (including calibration), STAT (measurement of an urgent specimen) startup, a pose, a pose release and the like. Alternatively, when deleting various kinds of information, backup may be carried out prior to the actual delete operation or may be carried out periodically at a predetermined interval.

Because of the capacity of the storage device, information to be backed up can be stored more than once. Depending on the backup condition configuration, backup may be set to occur twice for each condition. If such backup is carried out, the backed up information is stored under plural different conditions. To enable the easy retrieval of desired information from this stored backed up information, each backed up piece of information is equipped with tag information for identification. The operator can know the content of the database from this tag information and select desired backup information so as to carry out the recovery operation. The tag information to be applied to this backup information may include a time stamp including date, a device identifier, correction information inherent of the apparatus and the like. By displaying this tag information on the backup operation screen, instruction for backup operation can be carried out not through a local console but under a remote control from, for example, a service center computer.

As a condition that can be reproduced by this recovery, it is possible to restore the condition to a state before the power of the sample analysis control apparatus 1 or the analyzing unit 2 is turned OFF just before, a state before an error is detected or a state in which information is deleted or changed due to erroneous operation. As a timing for recovery of the state, the content for recovery is selected automatically or by manual input by the operator from plural recovery states backed up previously at restart timing of the analyzing apparatus or any timing.

By the aforementioned backup or recovery operation, the partition in an external storage device which should be backed up becomes clear, thereby preventing an occurrence of erroneous operation in either automatic or manual operation. Further, by dividing the storage means physically, an effective recovery from an unexpected crash can be carried out. Because all necessary information is backed up, the reliability of data is improved. Further, by using the hard disc as a storage means for the backup material, quick recovery and backup are achieved.

Moreover, because the backup and recovery are automatically carried out under predetermined conditions, an appropriate backup is achieved without carrying out the backup intentionally by the operator and in terms of recovery, the normal state can be quickly restored to a state required by the operator.

Alternatively, only when the content contained in a current partition (for example, E) coincides with the content contained in the backup target partition (for example, F), may recovery be selected as an option for the recovery. This can be employed when a deleted content is not desired to be recovered after the backup.

If the first hard disc 23 including partitions C, D, E is damaged, the content of the partitions C, D can be restored from recovery CD which are often added to the apparatus. Additionally, according to the function of the first embodiment, the partition E can be recovered easily, so that the reliability of the analyzing apparatus is improved thereby reducing a the load on the operator.

As an operation which should be supplemented to the above description, if the storage capacity of the first hard disc 23 is sufficient, all the partitions C, D, E including the partitions D, E and operating system (OS) may be backed up. Further, a third hard disc (not shown) may be added so as to intensify the backup function. Further, the content to be recovered can be verified by executing a content comparing software after the backup and recovery, thereby ensuring a secure, reinforced and stable system.

Second Embodiment

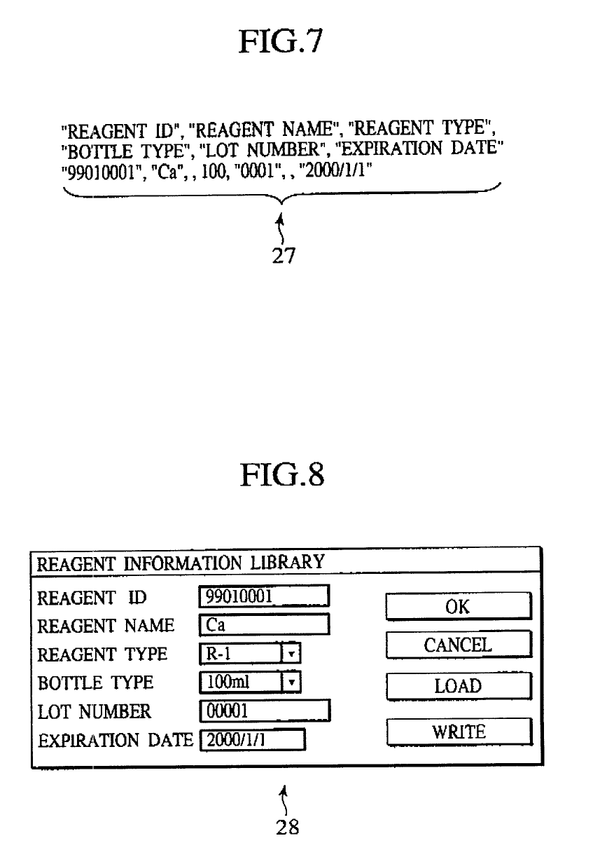

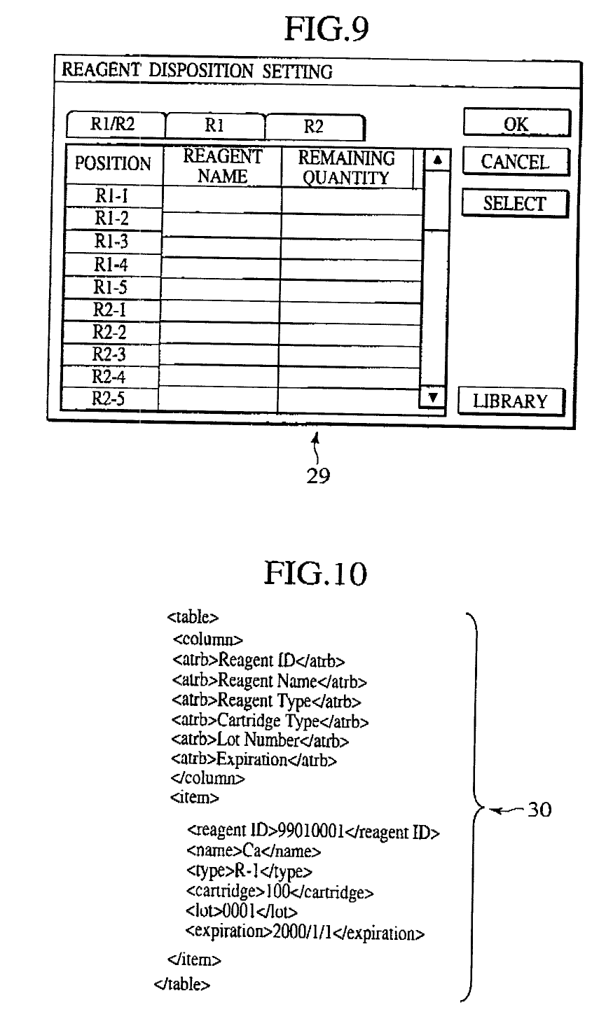

Hereinafter, with reference to FIG. 7 and FIG. 9, the second embodiment of the present invention will be described in detail regarding only the points that differs from the first embodiment in detail.

The second embodiment has the same structure as the first embodiment shown in FIG. 3. Data stored in the analysis related information database 23 is organized in a text file such as comma separated value (CSV) file and each data element (item) is provided with data item (element) identification header.

FIG. 7 shows an example of the header-provided CSV file 27 based on the structure of the analyzing apparatus of the present invention described in the first embodiment. By using this CSV file 27, reagent data 232 can be controlled or employed and the reagent data 232, the reference sample data 233, item definition file and the like can be imported or exported to and from the sample analyzing system. The removable media controller 13 in which a removable disc such as a floppy disk (FD) can be used is employed.

User interface for data control through the CSV file according to the second embodiment will be described with example reagent information.

(1) Registration Processing

FIG. 8 shows an example of individual data input screen in the sample analysis control apparatus 1 according to the second embodiment. The individual data input screen 28 is displayed on the display unit 20 so that an operator can register reagents into the reagent information library following this display. In this registration, these pieces of information can be written out into a floppy disk, for example, in a format of the CSV file 27 having a header of a set up reagent name element.

If the element name is written in a format added to element data like the CSV file 27 shown in FIG. 7, the kind and content of information can be interpreted and registered by software with reading a header consisting of element's name. Because the element name corresponding to element data is displayed at the same time, the operator can recognize what the element data indicates easily. Therefore, even if information arrangement order changes, it is possible to carry out a desired registration in correspondence with the header. The element name consisting of the header may be an identifier capable of identifying each element as well as just the name of the element.

By the aforementioned registration operation, plural reagent information are read into a memory or other storage device controlled by the sample analysis controller 21 of the sample analysis control apparatus 1 as reagent library following the individual data input screen 28 at a time. After that, the reagent information is registered as reagent library in which the reagent name or the reagent ID is added at a predetermined position of the analysis related information database 23 in the sample analysts control apparatus 1. Because the content of the registered reagent library is displayed on the display unit 20 through a library screen 29 shown in FIG. 9, for example, the operator can retrieve the content of the reagent library through the library screen 29.

On this library screen 29, the individual data input screen 28 is called up by selecting the “library button” for example. The operator then inputs and registers individual reagents into the individual data input screen 28. Alternatively, if library screen 29 is called up, an allocation position for individual inputted data is selected, the selection button is pressed, and a list of reagents registered through the individual data input screen 28 is displayed, thereby allowing the desired reagent data to be selected by the operator.

(2) Reading and Writing Data

Next, the reading and writing of the aforementioned reagent data will be described in detail. The reading is carried out through the following process. First, an element name such as “reagent ID” which exists at a first column in the header-provided CSV file 27 shown in FIG. 7 is picked out as fixed information. A storage region capable of storing the content corresponding to the fixed information by a appropriate amount (a number of necessary reagents in this embodiment) is held and data existing at a corresponding header position is read in. In the header-provided CSV file 27, second data “Ca” of a first reagent data is stored as the reagent name of the first reagent.

If it is necessary to inhibit reading of duplicate data, it is possible to have a structure in which the storage region is retrieved only by using reagent ID as a key and if it coincides with a read reagent, an error message indicating that “it cannot be registered because it is duplicate” is displayed on the display unit 20 and that step is skipped. It is also possible to have plural keys and use them for duplicate check.

Next, the writing process will be described in detail. Like the example of the CSV file 27 shown in FIG. 7, the element name is written on a first line and information stored preliminarily is written out on the second line and following line corresponding to the first line by a specified number or a required number.

By carrying out such reading and writing, in the sample analyzing system of the second embodiment, the header is recognized as a mark for each set content, so that it can be created and controlled easily outside the sample analyzing system in, for example, general-purpose spread sheet software. An apparatus manufacturer can collect reagent information easily from each reagent manufacturer and install it into the sample analyzing system preliminarily. Because an operator does not have to do anything but select reagent information, the amount of data input into the reagent library is small, preventing erroneous operation and thereby reducing a workload on the operator.

Third Embodiment

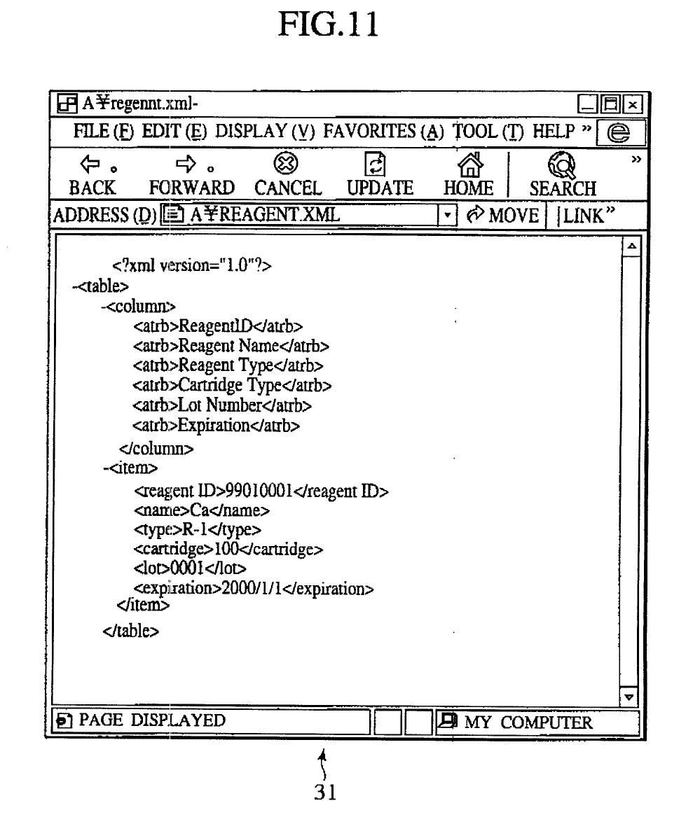

Hereinafter, the sample analyzing system and sample related information control unit according to the third embodiment of the present invention will be described in detail with reference to FIG. 10 and FIG. 11 regarding only points that differs from the first and second embodiments.

The third embodiment has the same structure as the first embodiment of the present invention shown in FIG. 3. Data stored in the analysis related information database 23 is described with, for example, extensible markup language (XML) and each data item (element) is provided with data item (element) identifying header to the data.

FIG. 9 is an example in which the content of the CSV file 27 shown in FIG. 7 is described with the XML file 30 of the third embodiment. The XML is a standard in which data style for information exchange is specified and the XML file 30 is a text data created under notation system of the XML. Thus, it can be edited by a general-purpose text editor and its hierarchy can be displayed with a general-purpose viewer 31 shown in FIG. 10.

With the viewer 31 and the XML file 30, the effects obtained from the second embodiment can be made more effective. Under the XML file 30, its independent tag can be defined. According to this system, a tag is defined for each of six attributes <atrb> defined in <column> and a character string and value corresponding to each tag are defined in <item>. By defining plural <item>'s, plural reagents can be defined.

Fourth Embodiment

Hereinafter, the fourth embodiment of the present invention will be described in detail regarding only points that differs from the first to third embodiments.

According to the second and third embodiments, information is written into, for example, such a removable media as floppy disk in order to read information from outside the analyzing apparatus of the present invention or fetch out information. However, if the general-purpose markup language (XML), as described in the third embodiment, is stored in the storage region of the analysis related information database 23 in the sample analysis control apparatus 1, information in the analysis related information database 23 can be controlled and operated directly from a remote computer through general-purpose software.

Any kind of information can be transmitted outside the network and received from outside according to the fourth embodiment as long as it is registered in the analysis related information database 23. For example, it includes mainly system configuration data 237, the measuring item parameter data 236, the maintenance data 238, the error log data 239 and the like.

The system configuration data 237, the measuring item parameter data 236, the maintenance data 238 and the error log data 239 can be stored in a temporary storage means controlled by the sample analysis controller 21 temporarily. For example, when this kind of information is transmitted by the online-communication unit 15 through a network, the transmission timing can be determined depending on a predetermined time interval and transmit the content stored in the temporary storage means.

The aforementioned information transmitted through the network may be inputted to the remote computer 3 shown in FIG. 3 so as to allow the correction of erroneous operation recoverable by monitoring and controlling operations carried out in the sample analyzing apparatus by this remote computer. By means of such an external connection through the network, a series of so called remote maintenance can be securely achieved, thereby leading to the reduction of down-size of the apparatus and improvement in reliability.

As means of connecting to the network, the online-communication unit 15 shown in FIG. 3 is used. This online-communication unit 15 allows connection to a remote computer through such network as the HIS and the LIS.

In the sample analyzing system and sample analysis control apparatus 1 of the above described embodiment, the partition which should be backed up is clarified thereby preventing an error by backing up securely by either automatic way or manual method. By separating the backup media physically from ordinary storage means, system highly resistant to damage can be formed. Because the backup/recovery can be carried out by selecting only necessary information, operating efficiency is improved and it can be finished in a short time. Further because all necessary information is backed up, the reliability is improved, and by using the HDD, high-speed operation can be carried out.

By importing a file obtained from manufacturer of a reagent and a reference sample into the sample analyzing system and making the operator select information which should be registered appropriately, the library can be registered directly in the sample analyzing system thereby making it possible to reduce a workload on the operator. Even if any file cannot be obtained from the manufacturer, if the file is once inputted manually, it can be shared among other apparatuses of the same type by exporting to them with their output function. Thus, the workload on the operator is reduced and further, that function can be used in other apparatus having this function, thereby reducing the workload on the operator.

Because the test facility data 240 necessary for the sample analyzing system can be selected and registered directly from the facility information file on a server computer 3 controlling the test facility data 240, the workload on the operator is reduced. Even if a file for controlling the inspecting facility information cannot be obtained, if the file is once inputted manually, it can be shared among other apparatuses of the same type, thereby leading to reduction of the workload on the operator. Further, this function can be used in other units having the same function, so that the workload on the operator can be reduced.

The condition of the sample analyzing system can be controlled easily from a remote place such as service center so as to take necessary measure for that apparatus, thereby making it possible to reduce the workload on the operator of the apparatus. A service person in the service center can display information file of the apparatus on his own client computer without use of a dedicated software and edit it if there is any problem thereby leading to improvement of service operation efficiency.

Further, data can be displayed or edited on any client computer outside as well as computer of the service center without use of the dedicated software, thereby making it possible to reduce the workload on the operator of the apparatus.

Further, because information necessary for the apparatus can be controlled integrally, the workload on the operator can be reduced.

As described in the above respective embodiments, the CSV file or XML file format may be used as data storage format in the analysis related information database 23 and they may be held in the form of binary file in the analysis related information database 23 and converted appropriately in the I/O controller 22, online-communication unit 15 or removable media controller 13 and stored temporarily when an interface with outside is executed.

The above described embodiments have been described to facilitate understanding of the present invention and are not described to restrict the present invention. Therefore, the respective elements disclosed in the above described embodiments include all design changes and equivalents belonging to the technical scope of the present invention.

In summary, according to the present invention, the workload of the control and maintenance of information related to the sample analysis can be reduced. Further, the backup is facilitated, the reliability is improved and recovery time is shortened. Moreover, the control and operation of information in the sample analyzing apparatus can be carried out easily from other apparatus or from a remote place.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A sample analyzing system for analyzing a sample, comprising:
an analyzing unit for analyzing requested item of a measured sample;
an analysis related information database for holding analysis related information necessary for analyzing said sample;
a database manager for storing inputted said analysis related information into said analysis related information database and outputting information from said analysis related information database; and
a controller for controlling storing said analysis related information into said analysis related information database and outputting therefrom in a file format complete with a header defining a data item identifier for each data item.

2. The sample analyzing system according to claim 1, further comprising:
an on-line communication unit for exporting said analysis related information into a database in other computer connected outside to said system and importing said analysis related information from the said other computer into said analysis related information database.

3. The sample analyzing system according to claim 2, wherein said on-line communication unit imports or exports said analysis related information in a file format provided with a header defining a data item identifier for each data item.

4. The sample analyzing system according to claim 1, wherein said file formal is XML format.

5. The sample analyzing system according to claim 1, wherein said file format is CSV format.

6. The sample analyzing system according to claim 1, further comprising:
an editor for editing said analysis related information.

7. The sample analyzing system according to claim 1, further comprising:
a display unit for displaying said analysis related information.

8. A sample analyzing system for analyzing a sample, comprising:
an analyzing unit for analyzing requested item of a measured sample;
an analysis related information database for holding analysis related information necessary for analyzing said sample;
a database manager for storing inputted said analysis related information into said analysis related information database and outputting information from said analysis related information database; and
a controller for converting said analysis related information into a file format complete with a header defining a data item identifier for each data item when storing said analysis related information into said analysis related information database and outputting therefrom.

9. The sample analyzing system according to claim 8, further comprising:
an editor for editing said header of converted analysis related information as an item name.

10. The sample analyzing system according to claim 9, further comprising:
an I/O controller for controlling display of inputting and outputting screen accessing said analysis related information database according to the editing in said editor.

11. The sample analyzing system according to claim 8, further comprising:
an on-line communication unit for exporting said analysis related information into a database in other computer connected outside to said system and importing said analysis related information from said other computer into said analysis related information database.

12. The sample analyzing system according to claim 11, wherein said on-line communication unit imports or exports said analysis related information in a file format provided with a header defining a data item identifier for each data item.

13. The sample analyzing system according to claim 8, wherein said converted file is described in XML format.

14. The sample analyzing system according to claim 8, wherein said converted file is described in CSV format.

15. A sample analyzing system for analyzing a sample, comprising:
an analyzing unit for analyzing requested item of a measured sample;
a first storage device for holding analysis related information necessary for analyzing said sample;
a database manager for storing inputted said analysis related information into said first storage device and outputting information from said first storage device; and
a backup recovery processor for backing up all or part of said analysis related information stored in said first storage device into a second storage device other than said first storage device, and, if necessary, restoring the backed up analysis related information in said second storage device into said first storage device.

16. The sample analyzing system according to claim 15, further comprising:
a controller for controlling storing said analysis related information into said first storage device and backing up thereof in said second storage device in a file format provided with a header defining a data item identifier for each data item.

17. The sample analyzing system according to claim 15, further comprising:
a controller for converting said analysis related information into a file format provided with a header defining a data item identifier for each data item when storing said analysis related information into said first storage device and outputting backing up thereof in said second storage device.

18. The sample analyzing system according to claim 15, further comprising:
a display unit for displaying a selecting screen for selecting target information to be backed up into said second storage device from information in said first storage device or target information to be restored into said first storage device from information in said second storage device.

19. The sample analyzing system according to claim 15, further comprising:
an online communication unit for connecting said first storage device and said second storage device with online network.

20. The sample analyzing system according to claim 16, wherein said file format is XML format or CSV format.

21. The sample analyzing system according to claim 17, wherein said file format is XML format or CSV format.
